(19) United States
(12) Patent Application Publication
(10) Pub. No.: US 2008/0004374 A1
(43) Pub. Date: Jan. 3, 2008

(54) WOOD-LIKE POLYMER COMPOSITES AND PRODUCTION METHODS THEREFOR

(76) Inventor: Roger W. Faulkner, Brighton, MA (US)

Correspondence Address: Brian M. Dingman, Esq.;Mirick, O'Connell, DeMallie & Lougee, LLP, 1700 West Park Drive, Westborough, MA, 01581-3941, US

(21) Appl. No.: 11/854,377

(22) Filed: Sep. 12, 2007

Related U.S. Application Data
(63) Continuation of application No. 10/925,551, filed on Aug. 25, 2004.
(60) Provisional application No. 60/497,343, filed on Aug. 25, 2003.

(51) Int. Cl. C08J 9/32

(52) U.S. Cl. 523/218; 523/219

(57) ABSTRACT

The present invention comprises syntactic organic fiber-reinforced polymer composites that are useful in “plastic wood” applications, including extruded wood replacements similar to those that are sold in commerce today, and also several novel applications, based on organic fibers with better chemical or thermo-oxidative stability than lignocellulosics. These novel materials involve blends of rigid hollow beads, at least one reinforcing fiber, and at least one polymer. This patent application also relates to a particularly desirable method to form these blends, based on use of a counter-rotating, non-intermeshing extruder (such as those produced by NFM Welding Engineers of Massillon, Ohio) to gently disperse the hollow rigid beads into a polymer melt with minimal breakage, followed by combination with organic fibers per se, or a polymer melt that contains organic fibers. Optionally said novel blends can contain additional fillers, processing aides, coupling agents, graft polymers, wetting agents, or other conventional compounding ingredients for plastics.

### CROSS REFERENCE TO RELATED APPLICATION

This application is a continuation of co-pending U.S. patent application Ser. No. 10/925,551, filed Aug. 25, 2004, which is based upon and claims the priority of the same applicant's U.S. Provisional Application of the same title filed Aug. 25, 2003, Application No. 60/497,343, the entire disclosure of which is incorporated herein by reference.

### BACKGROUND OF THE INVENTION

Mixtures of thermoplastic polymers, usually polyolefins, with cellulosic fibers derived from plants are well-known in commerce. Most commonly, these are mixtures of polyethylene or polypropylene with wood sawdust or other forms of wood waste, though combinations of polymers with stronger plant fibers derived from plants like jute, kenaf, or hemp for example, are also known in the prior art. These mixtures are known generically as “plastic wood,” since the major application is in the replacement of wood, especially in places where rot resistance is essential. Plastic wood composites are for example used to replace pressure treated woods in construction of decks and outdoor walkways. In such composites, the density of the natural fiber component is about 1.45 grams/cm³; this means that the composites themselves are usually above 1.0 grams/cm³. A 50% (by weight) natural fiber composite with polyethylene for example has a density around 1.125 grams/cm³ for example, compared to typical wood densities of 0.50-0.80 grams/cm³. Most prior art plastic wood composites are fully dense in the sense that they contain few voids, and as a result nails are not generally used in joining the pieces together (since there is nowhere for the material which is forced out of the way by the nail to go, nailing such composites usually raises ridges around the nail shaft and may also weaken the attachment significantly compared to using screws or bolts, or drilling pilot holes before nailing, because of crazing around the nails or screws). Also, the relatively high density of these materials has inhibited their adoption to some extent.

One conventional means to improve nailability and reduce density of plastic wood is to foam it. Foaming with gas bubbles does enhance nailability and reduce density, but it also reduces stiffness and increases creep rate significantly. Creep is a significant problem for many applications of prior art plastic wood (such as decking and outdoor furniture), so ordinary foaming creates a significant problem.

The closest patent known to the present invention is U.S. Pat. No. 5,866,641 by Ronden and Morin on “Process for the Production of Lightweight Cellular Composites of Wood Waste and Thermoplastic Polymers.” This patent describes composites of cenospheres, polymer, and wood flour; however the main objective of this patent was to use particularly economical filler (cenospheres) to make a low cost plastic wood extrudate. Claim 1 of this patent limits the patent to polymer composites containing both cenospheres and tall oil (or similar compounds) as compatibilizer and/or flow additive; the preferred embodiments include also wood flour and a blowing agent in cenosphere/wood fiber/polymer composites. U.S. Pat. No. 5,866,641 does not give any data on the breakage of the cenospheres. U.S. Pat. No. 5,866,641 prefers versions of the invention that are chemically foamed in addition to containing voids inside the cenospheres (conventionally foamed materials have much higher creep rate that syntactic foams based on a similar polymer matrix plus hollow beads that remain intact and bonded during creep).

The preferred embodiments of U.S. Pat. No. 5,866,641 involve recycling of wood waste, especially sawdust from particle board manufacturing, combined with cenospheres from a local power plant. According to U.S. Pat. No. 5,866,641 the preferred fiber source is 40-mesh wood flour, preferably having been pre-treated with a thermoset polymer (as is the manufacturing waste from particle board, flake board, or plywood manufacturing). It was important enough to the inventors of U.S. Pat. No. 5,866,641 to have 40-mesh particles that no example of the use of crude sawdust was even reported, even though using the crude sawdust would have been far more economical. We can therefore deduce that the inventors of U.S. Pat. No. 5,866,641 did not anticipate the use of much longer plant-based fibers. Such fine ground lignocellulosic feed particles cannot contain the long fibers that are preferred in the present invention.

U.S. Pat. No. 5,866,641 also states that the main matrix-phase polymers that are useful therein include polyethylene (PE), polypropylene (PP), and polyvinylchloride (PVC), and that PVC is the preferred matrix polymer. All the cited examples had PVC as the matrix polymer. (PVC is not preferred for the long-fiber composites of the present invention.) U.S. Pat. No. 5,866,641 describes a preferred manufacturing process in which 40-mesh wood flour is first mixed around 50/50 with cenospheres and about 5% depitched tall oil in a high intensity mixer (such as a Herschel mixer for example). Preferably, the intensive mixing raises the temperature to around 90° C. The application of the tall oil to the mixed fillers makes the mixture more uniform, and improves its feeding behavior into an extruder, and its mixing behavior with polymers in the extruder. This mixture may be combined with PVC powder in the same high intensity mixer, then the entire mixture can be fed to an extruder, or alternatively, the mixture of filler particles and tall oil can be fed into the extruder with the PVC polymer, either in the same feed port or in different ports.

A very important point about the materials of U.S. Pat. No. 5,866,641 is that in all cases, properties other than density (flex modulus, flex strength, tensile strength, tensile modulus, and tensile elongation) were degraded (see Table 14 of U.S. Pat. No. 5,866,641). This is very different than the results obtained from the longer fibers used in the present invention. Furthermore, U.S. Pat. No. 5,866,641 did not mention the advantages of fully dense syntactic foam over blown foam or mixed syntactic/blown foam in terms of resistance to creep.

NFM Welding Engineers' (WE) trade publication, “We survived with 3M,” describes the use of a WE counter-rotating, non-intermeshing (CRNI) twin screw extruder to form mixtures of fairly low density hollow glass beads (Scotchlite A-20 from 3M Corporation, average density ˜0.20 gram/ml) with polymers, with low breakage. This publication did not describe or envision incorporation of fibers into these syntactic composites.

Mixtures of polyolefins with hollow glass beads are used in commerce to prepare “tapes” to insulate oil pipelines under the ocean. Although the author is aware of no examples in which organic fibers were incorporated into these insulating syntactic tapes, it is believed that some materials in commerce combine hollow glass beads, chopped glass fiber, and polymers.

### SUMMARY OF THE INVENTION

The materials of the present invention comprise combinations of hard, nearly rigid hollow beads (“hollow beads” hereafter) made of polymer, glass, ceramic, or metal (examples in the literature have been variously identified as hollow spheres, cenospheres, hollow glass beads, or hollow beads for example), with average true density below 0.8 grams/ml, with a reinforcing organic fiber filler, and a polymer matrix. The reinforcing fiber filler can either be a natural lignocellulosic fiber (examples include hemp, kenaf, flax, and jute for example), or a synthetic organic polymer fiber. The processing temperature for the polymer matrix must be below the softening or melting temperatures of the hollow beads, and must also be low enough to not melt or degrade the fibers. These compositions of matter can achieve nearly void-free composites with density in the range of available woods, and strength greater than similar prior art syntactic foams (similar compositions but without the reinforcing fiber). (“Void-free” in this case means no gas bubbles in the composite other than those contained inside the hollow beads.)

The invention is in one aspect a composition of matter containing a matrix-phase polymer, an organic fiber, and hollow glass, metal, polymeric, or ceramic hollow beads. Compared to prior art plastic wood composites, the syntactic composites of the present invention are lower in density, closer to the range of wood product densities. The presence of the hollow beads improves the joining of the novel composites of this invention with nails, provided that the grade of hollow beads used in the composite collapses under the pressure created as a nail is driven into the composite, creating a void into which material can move as the nail is driven in. (This is analogous to what happens when a nail is driven into wood, in which the collapse of wood cells accommodates the lignocellulosic volume that is pushed out of the way by the nail.) Compared to similar conventionally foamed plastic wood composites (which contain gas bubbles rather than hollow beads) of the prior art, the novel composites are more dimensionally stable, because the gas bubbles are contained in rigid shells which resist deformation. Dimensional stability is further enhanced if good bonding between the hollow beads and the matrix polymer are achieved.

The invention is in another aspect, a preferred method to form particular versions of these blends in which the matrix-phase polymer is a thermoplastic, and the particular hollow beads used are relatively low density (and therefore, rather weak), based on use of a counter-rotating, non-intermeshing (CRNI) extruder (such as those produced by NFM Welding Engineers of Massillon, Ohio) to gently disperse hollow rigid beads into a polymer melt with minimal breakage, to form a syntactic polymer melt blend, followed by combination of the syntactic polymer melt blend with organic fibers per se, or a pre-formed polymer melt that already contains organic fibers. One specific way to prepare the compositions of the present invention involves a single screw extruder in which a first zone masticates and melts the matrix-phase polymer in a previously compounded organic fiber composite, then a syntactic polymer melt blend (prepared in a separate CRNI extruder) based on a compatible matrix-phase polymer is introduced though a side feed port into the single screw extruder which subsequently mixes the two melt streams and extrudes the organic fiber-reinforced syntactic through a die. Note that the relative importance of the preferred production method depends on the crush strength of the hollow rigid beads; in the case of relatively thick-walled, strong beads (such as 3M's Scotchlite K46 or S60 hollow glass beads, or cenospheres with average density above 0.6 gram/ml) a variety of methods can be used to form the composites of the present invention with acceptable breakage.

The invention is in another aspect, preferred formulations of the composites of this invention in which the matrix-phase polymer is a thermoset polymer. Polyurethanes, epoxy-based polymers and various combinations of polymerizable monomers with polymers dissolved therein are preferred among the thermoset polymers. An especially versatile way to formulate thermosets of the present invention is to create formulations that are capable of reaction wave polymerization. The basic principles of reaction wave polymerization are defined in the journal article “Reaction Wave Polymerization: Applicability to Reactive Polymer Processing”, Polymer Process Engineering 3, 113-126, 1985. Reaction wave polymerization (RWP) requires that a sufficiently exothermic polymerization to cause the system temperature to increase significantly occurs. RWP works as a nearly adiabatic process, and the reaction waves occur as a polymerizable monomer mixture (typically including thermally-activated initiators and/or catalysts for the polymerization reactions) is polymerized exothermically. RWP can propagate through very thick cross-sections, and has the special property that shrinkage occurs locally as the polymerization wave propagates through the system; therefore, by maintaining pressurization of the mold during polymerization, shrinkage stress can be minimized (because the shrinkage is allowed to occur as the wave propagates through, there is a much lower internal stress due shrinkage than is generally the case if the entire part polymerizes in unison. In many cases RWP-capable monomer systems would get too hot if they did not contain a substantial amount of filler. The particular organic fiber/hollow bead filler system of this invention yields RWP-capable systems with especially desirable properties.

### DETAILED DESCRIPTION AND PREFERRED EMBODIMENTS OF THE INVENTION

The invention is in one aspect a composition of matter containing a matrix-phase polymer (which can be either thermoplastic or thermoset), an organic polymeric fiber of sufficient length to be reinforcing, and hollow rigid beads. The strength of the hollow beads can be either more or less than the strength of the surrounding polymer. If the hollow beads break before the polymer breaks, the collapse of the hollow beads can contribute significantly to toughness (especially impact strength) of the overall composition. This is one reason that it is especially desirable to be able to incorporate relatively weak, low density hollow beads; low density hollow beads are also desirable because low density in the final composite is highly desirable for various reasons. Since low density hollow beads are intrinsically weak, the incorporation of these hollow beads into thermoplastics in such a way as to not collapse a majority of the hollow beads during processing is highly desirable.

Particular combinations of materials are especially useful in different applications. In general (unlike prior art U.S. Pat. No. 5,866,641, where PVC is the preferred matrix phase polymer) polyolefins are preferred as matrix-phase thermoplastic polymers in the present invention, mainly because of environmental considerations and recyclability. For example, where high heat distortion temperature (HDT) is especially important, a highly isotactic PP polymer is preferred as the matrix polymer; if low thermal conductivity is important, then a PP polymer or blend of PP polymers is preferred for the matrix. In those cases where raw material cost is the dominant consideration, PE or mixed PE/PP scrap may be the best matrix phase polymer, combined with cenospheres (the cheapest hollow rigid beads). In the case where nailability of the syntactic boards of this invention is the key consideration, at least a portion of the hollow beads must collapse as the nail is driven into the board, which implies a fairly low density hollow bead, such as glass beads with density between 0.20 to 0.40 gram/ml. In order to incorporate these low density hollow beads into a thermoplastic, it is highly desirable to use a counter-rotating, non-intermeshing extruder.

In most cases, natural lignocellulosic fibers derived from annual growth plants like hemp, sisal, jute, or kenaf are the preferred fibers for the composites of this invention. The most preferred fiber among the natural fibers is the bast fiber from kenaf. Long fibers, up to several centimeters in length, are desirably used in the composites of the present invention that incorporate kenaf bast fibers. In all cases where natural lignocellulosic fibers are used, care must be taken to minimize melt temperature and residence time of the fibers above 180° C. Brief exposure to temperatures as high as 210° C. can be tolerated during processing however.

Synthetic organic polymer fibers can also be desirably used in the composites of this invention. In particular, waste fibers of polyamides and/or polyesters, as may be produced by textile mills and the like, are sometimes quite economical. Use of such fibers, especially from carpet waste, is an especially desirable implementation of the present invention. In this case, maximum processing temperature must be below the melting temperature if the organic fibers and how far below the melting temperature will depend somewhat on the crystallinity of the organic fibers.

Non-flammable synthetic organic polymer fibers can also be desirably used in the composites of this invention, to reduce flammability. Examples of such fibers include polyaramid, polyphenylene sulfide, and various fluoropolymers, for example.

Another desirable object of the invention is the use of the novel compositions of the invention for furniture in which the low thermal diffusivity of the furniture is especially desirable, such as sauna furniture or outdoor furniture which might be heated to an uncomfortable temperature by the sun, or get so cold during the winter as to be uncomfortable to sit down on. In these particular applications, low density hollow beads (0.3 to 0.4 gram/ml) are especially desirable in combination with polypropylene or a thermoset polymer system.

Other embodiments will occur to those skilled in the art and are within the following claims:

What is claimed is:

1. Polymer composites comprised of combinations of hollow beads made of glass, ceramic, polymers, carbon, or metal with a polymer matrix and a reinforcing organic polymeric fiber filler, in which individual fibers longer than 2 millimeters predominate, and in which processing of the overall composition occurs below the melting or degradation temperatures of both the fibers and the hollow beads.

2. Polymer composites of claim 1 that contain at least 10% by weight of a natural fiber and at least 5% by weight of hollow beads.

3. Polymer composites of claim 1 that contain at least 10% by weight of a synthetic polymeric fiber with melting or degradation temperature above 200° C., and at least 5% by weight of hollow beads.

4. Fire resistant polymer composites of claim 3 that contain at least 10% by weight of a synthetic polymeric fiber with limiting oxygen index for combustion above 22%.

5. Sauna furniture, including walls, floors, ceilings, benches, and railings, made of polymer-based, fiber-reinforced syntactic foam of claim 2, in which the hollow beads comprise at least 25% by volume of the entire composite.

6. Sauna furniture, including walls, floors, ceilings, benches, and railings, made of polymer-based, fiber-reinforced syntactic foam of claim 3, in which the hollow beads comprise at least 25% by volume of the entire composite.

7. Reaction wave polymerizable formulations containing monomers; hollow beads made of glass, ceramic, polymers, carbon, or metal; and a reinforcing organic polymeric fiber filler, which after reaction wave polymerization yield polymer composites of claim 1.

8. Two part polymerizable systems comprised of monomeric and or oligomeric chemicals; hollow beads made of glass, ceramic, polymers, carbon, or metal; and a reinforcing organic polymeric fiber filler, which react after mixing to yield polymer composites of claim 1.

9. Epoxy-based two part systems of claim 8.

10. Isocyanate-based two part systems of claim 8.
